(19) United States
(12) Patent Application Publication
(10) Pub. No.: US 2008/0082327 A1
(43) Pub. Date: Apr. 3, 2008

(54) Sound Processing Apparatus

(75) Inventors: Atsunobu Murase, Kanagawa (JP); Shuichi Sakamoto, Miyagi (JP); Youichi Suzuki, Miyagi (JP); Tetsuaki Kawase, Miyagi (JP); Toshimitsu Kobayashi, Miyagi (JP)

Correspondence Address: PEARNE & GORDON LLP, 1801 EAST 9TH STREET, SUITE 1200, CLEVELAND, OH, 44114-3108, US

(73) Assignees: MATSUSHITA ELECTRIC INDUSTRIAL CO., LTD., Kadoma-shi, Osaka (JP); TOHOKU UNIVERSITY, Sendai-shi, Miyagi (JP)

(21) Appl. No.: 11/575,134

(22) PCT Filed: Sep. 13, 2005
(86) PCT No.: PCT/JP05/16787

§ 371 Date: Mar. 13, 2007

(30) Foreign Application Priority Data
Sep. 17, 2004 (JP) 2004-272159

(51) Int. Cl. H04R 25/00; G10L 15/00

(52) U.S. Cl. 704/234; 381/320; 704/E15.001

(57) ABSTRACT

It is an object of the present invention to provide a sound processing apparatus which can allow a user to hear a sound with improved intelligibility even if the sound is hard to hear. The analyzing means 15 is adapted to analyze the input signal from the A/D converter 12, to detect, on the basis of an analysis of the input signal, a frequency band corresponding to a masking sound and a frequency band corresponding to a masked sound, and to change the cutoff frequencies of the lowpass and highpass filters 13 and 14 on the basis of the analysis of the input signal to ensure that the frequency band corresponding to a masking sound is included in a signal from one of the first and second sound output means 18 and 19, and the frequency band corresponding to a masked sound is included in a signal from the other of the first and second sound output means 18 and 19.

### TECHNICAL FIELD OF THE INVENTION

This invention relates to a sound processing apparatus, and more particularly to a sound processing apparatus for compensating for diminished hearing or the like.

### DESCRIPTION OF THE RELATED ART

Deafness is broadly classified into conductive deafness and sensorineural deafness different in injured parts from the conductive deafness.

The conductive deafness is characterized in that a sound is hardly transmitted to an inner ear. If the sound is normally transmitted to the inner ear, acoustic nerves inside the inner ear can be normally stimulated in response to the sound. Therefore, one's conductive deafness can be compensated by an amplified sound inputted in the inner ear.

On the other hand, sensorineural deafness is characterized in that, even if sounds are normally transmitted to inner ears, acoustic nerves inside the inner ears cannot be stimulated in response to the transmitted sounds by reason of deformation or disappearance of sensor cells. As a result, sensorineural deafness deteriorates auditory functions such as for example frequency selectivity and temporal resolution, and gives rise to a loudness recruitment phenomenon.

The loudness recruitment phenomenon is characterized in that hearing organs of hearing-impaired person is higher in minimum audible threshold than those of normal hearer, and not so different, in threshold on unpleasantness of loud sound, from normal hearer. As a result, when the sound exceeds the minimum audible threshold, the hearing-impaired person feels that the sound is rapidly increased in loudness.

In general, the conventional hearing aid apparatus is, in the light of conductive deafness and this recruitment phenomenon, adapted to amplify a sound with a gain adjusted on the basis of user's reduced auditory property,. and to allow the user to hear the amplified sound by one ear, or by both ears.

On the other hand, the reduction in frequency selectivity engenders remarkable disadvantages through large and extensive masking, particularly the masking of middle- and high-frequency components by intense low-frequency components, that is, the so-called upward spread of masking. In a conventional method of allowing hearing-impaired person to hear a sound with intelligibility by reducing masking effect, the sound is divided into two sound sections to be respectively outputted to his/her ears.

When, for example, a sound is divided into two sections corresponding to respective ears under the condition that right- and left-channel sounds are synchronized from the respective sections, the hearing-impaired person feels that the right- and left-channel sounds are clear in comparison with the original sound (see, for example, non-patent document 1).

When, for example, a sound is divided into eighteen sections to be alternatively allocated to two groups corresponding to respective ears under the condition that right- and left-channel sounds are synchronized from the respective groups, the hearing-impaired person feels that the right- and left-channel sounds are clear in comparison with the original sound (see, for example, non-patent document 2).

FIG. 9 is a block diagram showing a conventional hearing aid apparatus.

As shown in FIG. 9, the conventional hearing aid apparatus comprises a sound input means 1

01 having an analog sound signal inputted therein, the analog sound signal being indicative of a sound, an analog-to-digital converter (A/D converter) 102 for converting the analog signal into a digital signal, a left-channel bandpass filter 103 constituted by bandpass filters 103a to 103i having respective signals passed therethrough, the signals corresponding to respective frequency ranges, a right-channel bandpass filter 104 constituted by bandpass filters 104a to 104i having respective signals passed therethrough, the signals corresponding to respective frequency ranges, a left-channel adder 105 for synthesizing the signals outputted by the left-channel bandpass filter 103, a right-channel adder 106 for adding the signals outputted by the right-channel bandpass filter 104, a left-channel digital-to-analog converter (left-channel D/A converter) 107 for converting a digital signal to an analog signal, a left-channel digital-to-analog converter (right-channel D/A converter) 108 for converting a digital signal to an analog signal, left-channel sound signal output means 109 for converting the analog signal outputted by the left D/A converter 107 into a left-channel sound, and outputting the left-channel sound to one's left ear, and right-channel sound signal output means 110 for converting the analog signal outputted by the right D/A converter 108 into a right-channel sound, and outputting the right-channel sound to one's left ear.

In the above-mentioned conventional hearing aid apparatus, the analog sound signal inputted into the sound input means 101 is converted by the A/D converter 102 into a digital signal to be outputted to the right- and left-channel bandpass filters 103 and 104.

The bandpass filters 103a to 103i of the left-channel bandpass filter 103 output sub-band signals corresponding to designated frequency bands to the left channel adder 105 on the basis of comb-like frequency characteristic shown in FIG. 10, while the left channel adder 105 synthesizes a left channel signal from the sub-band signals. The left channel signal is then converted into an analog signal by the D/A converter 107. The analog signal is then converted by the left channel sound output means 109 into a sound to be outputted to user's left ear.

The bandpass filters 104a to 104i of the right-channel bandpass filter 104 output sub-band signals corresponding to designated frequency bands to the right channel adder 106 on the basis of comb-like frequency characteristic shown in FIG. 10, while the right channel adder 106 synthesizes a right channel signal from the sub-band signals. The right channel signal is then converted into an analog signal by the D/A converter 107. The analog signal is then converted by the right channel sound output means 110 into a sound to be outputted to user's right ear.

From the foregoing description, it will be understood that the conventional hearing aid apparatus can allow a user to hear a sound with intelligibility by reducing masking of frequency bands by reason that the sound is divided into two sound sections to be respectively outputted to his/her ears. non-patent document 1: Barbara Franklin, “The Effect of Cobining low- and high-frequency passbands on consonant recognition in the hearing-impaired”, (U.S.), Journal of Speech and Hearing Research 1975 non-patent document 2: D. S. Chaudhari and P. C. Pandey, “Dichotic Presentation of Speech Signal Using Critical Filter Bank for Bilateral Sensorineural Hearing Impairmanet”, (U.S.), Proc. 16th ICASSO' 98, 1998

### DISCLOSURE OF THE INVENTION

### PROBLEMS TO BE SOLVED BY THE INVENTION

The conventional hearing aid apparatus expects an effect of allowing a user to hear a sound with intelligibility under the condition that the feature of the inputted voice sound meets a predetermined dividing condition. However, the feature of the inputted voice sound does not always meet the dividing condition by reason that woman's voice is different in formant frequency from man's voice, the feature of the inputted voice sound is dependent on the type of vowel and the combination of vowel and consonant.

In voice sound, bowel has a formant structure, and in general, larger in signal level than consonant. When, for example, two voice sounds are heard in series, forward and backward masking exist. The “forward masking” is intended to mean that trailing sound is masked by leading sound, while the “backward masking” is intended to mean that leading sound is masked by trailing sound.

It is extremely difficult for hearing-impaired person to hear continuous syllabic sounds in conversation without being affected by upward and temporal masking, in comparison with normal hearer, by reason that hearing-impaired person has hearing organs reduced in temporal resolution, and trailing consonant and vowel are masked by formant components of leading vowel, the trailing consonant and vowel being considerably smaller than the leading vowel.

Additionally, frequency bands of the upward and temporal masking are dependent on frequency components of vowels and consonants, and high and low voices.

The conventional hearing aid apparatus, however, encounters such a problem that the sound is always improved in intelligibility even if the user hears, with his/her ears, sounds into which the sound is divided at a predetermined frequency.

It is, therefore, an object of the present invention to provide a sound processing apparatus which can allow a user to hear a sound with improved intelligibility even if the sound is hard to hear.

### MEANS FOR SOLVING THE PROBLEMS

The sound processing apparatus according to the present invention comprises: at least one frequency characteristic changing means for changing frequency characteristics corresponding to right and left ears, and changing an input signal on the basis of the changed frequency characteristics; and analyzing means for analyzing the input signal, and controlling the frequency characteristic changing means on the basis of an analysis of the input signal to allow the frequency characteristic changing means to change the input signal into right and left channel signals corresponding to the ears.

The sound processing apparatus thus constructed as previously mentioned can allow a user to hear a sound with improved intelligibility by changing the sound into right and left channel sounds to be respectively outputted to his/her ears.

In the sound processing apparatus according to the present invention, the analyzing means may be adapted to detect, from a plurality of frequency bands of the input signal, a frequency band corresponding to a masking sound and a frequency band corresponding to a masked sound, and to control the frequency characteristic changing means to ensure that the frequency band corresponding to the masking sound is included in one of the right and left channel signals, and the frequency band corresponding to the masked sound is included in the other of the right and left channel signals.

The sound processing apparatus thus constructed as previously mentioned can allow a user to hear a sound with improved intelligibility without being affected by a masking effect by changing the sound into right and left channel sounds to be respectively outputted to his/her ears, the frequency band corresponding to the masking sound being included in one of the sounds, the frequency band corresponding to the masked sound being included in the other of the sounds.

In the sound processing apparatus according to the present invention, the analyzing means may be adapted to analyze, in vowel, the input signal, and to allow the frequency characteristic changing means to change the frequency characteristics on the basis of an analysis in vowel of the input signal.

The sound processing apparatus thus constructed as previously mentioned can allow a user to hear a sound with improved intelligibility without being affected by masking effects corresponding to respective vowels by changing the frequency characteristics on the basis of an analysis in vowel of the input signal.

In the sound processing apparatus according to the present invention, the analyzing means may be adapted to detect one or more formant frequencies from the input signal, and to identify the type of vowel on the basis of the detected formant frequencies.

The sound processing apparatus thus constructed as previously mentioned can allow a user to hear a sound with improved intelligibility without being affected by a masking effect by identifying the type of vowel on the basis of the detected formant frequencies.

In the sound processing apparatus according to the present invention, the analyzing means may be adapted to detect a first formant frequency from the input signal, and to allow the frequency characteristic changing means to change the frequency characteristics on the basis of an analysis in vowel of the input signal.

The sound processing apparatus thus constructed as previously mentioned can allow a user to hear a sound with improved intelligibility without being affected by a masking effect by changing the frequency characteristics on the basis of an analysis in vowel of the input signal.

In the sound processing apparatus according to the present invention, the analyzing means may be adapted to allow the frequency characteristic changing means to change the frequency characteristics to allow a frequency band corresponding to the first formant frequency to be outputted to one of the ears, and to prevent the frequency band corresponding to the first formant frequency from being outputted to the other of the ears.

The sound processing apparatus thus constructed as previously mentioned can allow a user to hear a sound with improved intelligibility without being affected by a masking effect resulting from the first formant frequency.

In the sound processing apparatus according to the present invention, the frequency characteristic changing means may include lowpass and highpass filters. The analyzing means may be adapted to change, in cutoff frequency, the lowpass and highpass filters on the basis of the analysis of the input signal, and to allow the lowpass and highpass filters updated in cutoff frequency to filter the input signal.

The sound processing apparatus thus constructed as previously mentioned can allow a user to hear a sound with improved intelligibility without being affected by a masking effect resulting from the first fornant frequency by changing, in cutoff frequency, the lowpass and highpass filters on the basis of the analysis of the input signal.

In the sound processing apparatus according to the present invention, the analyzing means may be adapted to detect, from the a plurality of frequency bands of the input signal, a frequency band corresponding to a masking sound and a frequency band corresponding to a masked sound, and to change, in cutoff frequency, the lowpass and highpass filters on the basis of on the basis of the detected frequency bands.

The sound processing apparatus thus constructed as previously mentioned can allow a user to hear a sound with improved intelligibility without being affected by a masking effect resulting from the first formant frequency by changing, in cutoff frequency, the lowpass and highpass filters on the basis of on the basis of the detected frequency bands.

The sound processing apparatus according to the present invention may further comprise two amplifying means for amplifying the frequency bands of the input signal on the basis of adjustable gains corresponding to the frequency bands of the input signal; and rate-of-loudness-compensation calculating means for calculating powers of the frequency bands of the input signal, and adjusting the gains of the amplifying means on the basis of the calculated powers of the frequency bands of the input signal, wherein the rate-of-loudness- compensation calculating means is adapted to amplify signals passed through the lowpass and highpass filters on the basis of the gains updated by the rate-of-loudness-compensation calculating means.

The sound processing apparatus thus constructed as previously mentioned can allow a user to hear a sound at an appropriate volume with improved intelligibility without being affected by a masking effect resulting from the first formant frequency by reason that the two amplifying means is adapted to amplify the frequency bands of the input signal on the basis of the gains adjusted on the basis of a hearing-impaired person's auditory property.

In the sound processing apparatus according to the present invention, the analyzing means may be adapted to detect first and second formant frequencies from the input signal, to identify the type of vowel on the basis of the detected first and second formant frequencies, and to change, in cutoff frequency, the lowpass and highpass filters on the basis of an analysis in vowel of the input signal.

The sound processing apparatus thus constructed as previously mentioned can allow a user to hear a sound with improved intelligibility without being affected by a masking effect resulting from the first formant frequency by changing, in cutoff frequency, the lowpass and highpass filters on the basis of an analysis in vowel of the input signal.

### ADVANTAGEOUS EFFECT OF THE INVENTION

The sound processing apparatus according to the present invention can allow a user to hear a sound with improved intelligibility by reason that the analyzing means is adapted to analyze the input signal, and to control the frequency characteristic changing means on the basis of an analysis of the input signal to allow the frequency characteristic changing means to change the input signal into right and left channel signals corresponding to the ears.

### BRIEF DESCRIPTION OF THE DRAWINGS

FIG. 1 is a block diagram showing the first embodiment of the sound processing apparatus according to the present invention.

FIG. 2(a) is a graph showing intelligibility defmed with respect to frequency under the condition that VCV syllabic sound including a preceding vowel /a/, and being divided at each frequency into two sound sections to be heard by respectively ears. FIG. 2(b) is a graph showing intelligibility defined with respect to frequency under the condition that VCV syllabic sound including a preceding vowel /u/, and being divided at each frequency into two sound sections to be heard by respective ears.

FIG. 3 is a block diagram showing another embodiment modified from the first embodiment of the sound processing apparatus according to the present invention.

FIG. 4 is a block diagram showing a further embodiment modified from the first embodiment of the sound processing apparatus according to the present invention.

FIG. 5 is a block diagram showing the second embodiment of the sound processing apparatus according to the present invention.

FIG. 6 is graphs showing loudness compensation gains adjusted in each frequency band in the second embodiment of the sound processing apparatus according to the present invention.

FIG. 7 is a block diagram showing another embodiment modified from the second embodiment of the sound processing apparatus according to the present invention.

FIG. 8 is graphs showing loudness compensation gains adjusted in each frequency band in another embodiment modified from the second embodiment of the sound processing apparatus according to the present invention.

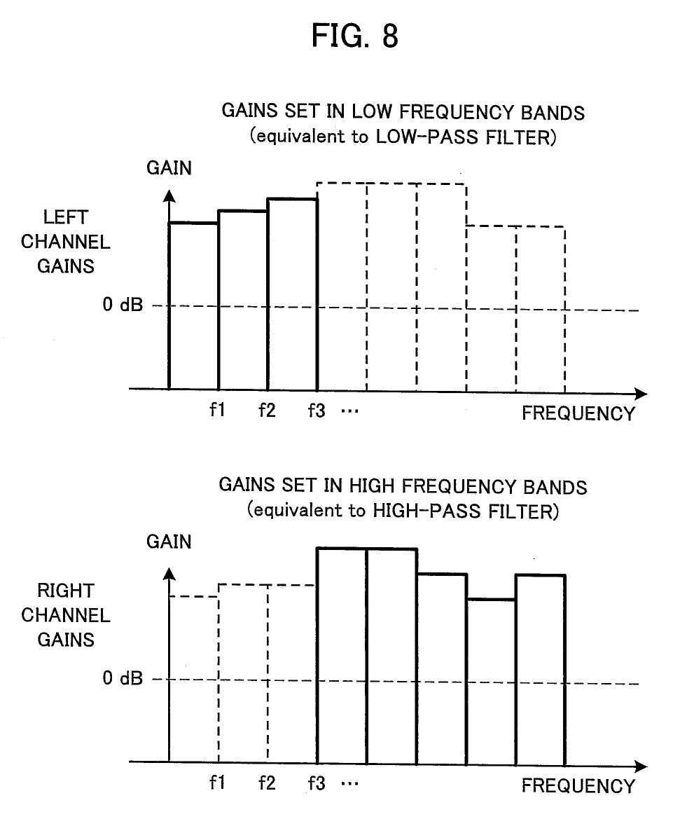

FIG. 9 is a conventional sound processing apparatus functioning as a hearing aid.

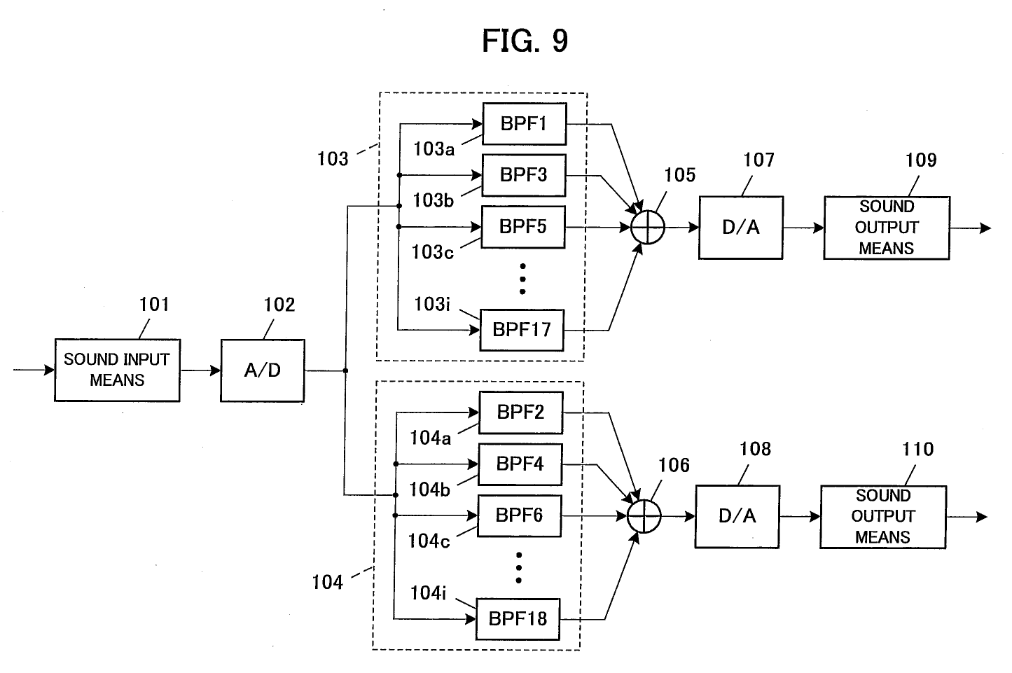

FIG. 10 is graphs showing frequency characteristics of the conventional sound processing apparatus shown in FIG. 9, the sound is divided, on the basis of the frequency characteristics, into two sound sections corresponding to right and left ears.

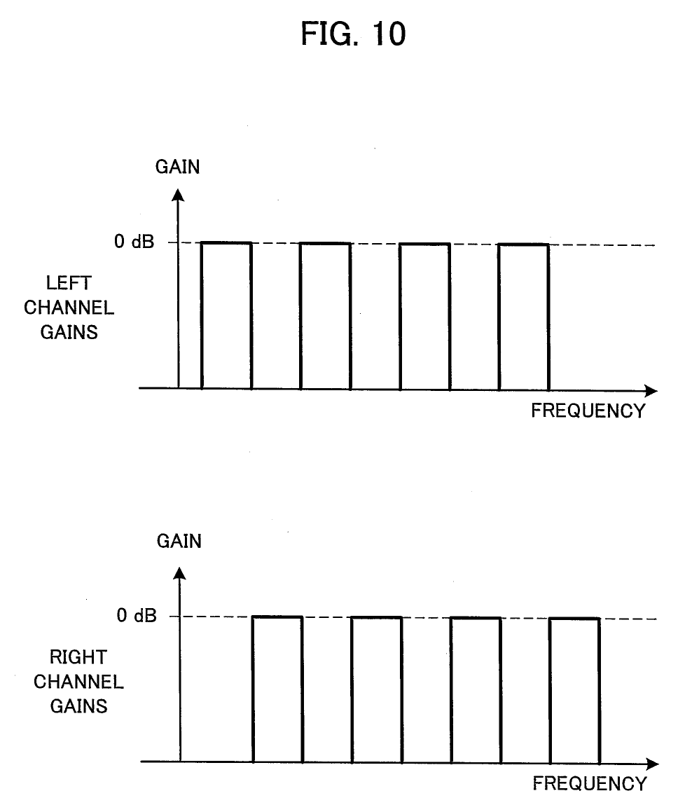

### EXPLANATION OF THE REFERENCE NUMERALS

11: sound input means
12: analog-to-digital converter
13: lowpass filter
14: highpass filter
15: analyzing means
16: first analog-to-digital converter
17: second analog-to-digital converter
18: first sound output means
19: second sound output means
20: first all-pass filter
21: second all-pass filter
22: analyzing means
23: first switch
24: second switch
25: first adder
26: second adder
31: first amplifying means for each frequency range
32: second amplifing means for each frequency range
33: calculating means for loudness compensation
34: analyzing means
35: first amplifying means for each frequency range
36: second amplifying means for each frequency range
101: sound input means
102: analog-to-digital converter
103: left-channel bandpass filter bank
103a to 103i: bandpass filters
104: right-channel bandpass filter bank
104a to 104i: bandpass filters
105: right-channel adder
106: right-channel adder
107: left-channel digital-to-analog converter
108: right-channel digital-to-analog converter
109: left-channel sound output means
110: right-channel sound output means

### DESCRIPTION OF THE PREFERRED EMBODIMENTS

The following description will be directed to a hearing aid method of allowing a hearing-impaired person to hear a sound with improved intelligibility by dividing the sound into two sections to be respectively outputted to his/her ears. It is well known that the hearing-impaired person feels that a sound is improved in intelligibility by hearing, by respective ears, two sections into which the sound is divided. However, nobody has known how to divide the sound into two sections.

The inventers have conducted experiments on whether or not the hearing-impaired person feels that the sound is improved in intelligibility by hearing, by respective ears, two sound sections into which the sound is divided with on the basis of vowel-consonant-vowel (VCV) syllabic sound.

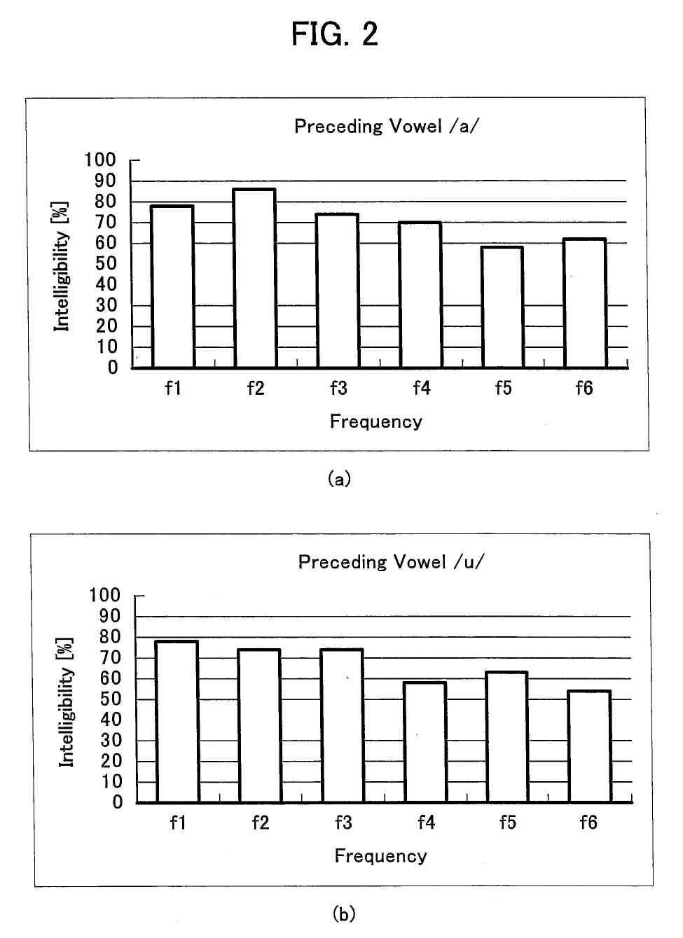

As a result, the inventers have found that the sound is improved in intelligibility under the condition that the sound is divided into two sound sections at a frequency determined on the basis of the type of preceding vowel. FIG. 2 is graphs showing, as an example, intelligibility defmed with respect to frequency under the condition that VCV syllabic sound including a preceding vowel, and being divided at each frequency into two sound sections.

In this experiment, the sound is divided into two sound sections corresponding to respective ears. One of the sound sections includes low frequency components processed in lowpass filter (LPF), while the other of the sound sections includes high frequency components processed in highpass filter (HPF).

The vowel-consonant-vowel (VCV) syllabic sounds include respective preceding vowels /a/ and /u/, and is divided at a frequency defined at the vicinity of formant frequency.

The transverse axis indicates “frequency” at which the sound is divided into two sound sections, while the vertical axis indicates “intelligibility” with which the hearing-impaired person hears the sound.

As shown in FIG. 2, the inventors have found that the intelligibility of the sound is varied in response to a frequency at which the sound is divided into two sound sections, and further found that a frequency at which the intelligibility of the sound is maximized is varied in response to the type of vowel when the sound is divided at the frequency into two sound sections.

From the above-mentioned experiments, the inventers have found that syllabic sound just after each vowel is improved in intelligibility by reason that the syllabic sound is divided, at a frequency to be appropriately determined on the basis of the features of the inputted sound signal, into two sound sections to be respectively outputted to ears.

More specifically, the method can allow hearing-impaired person to hear a sound with improved intelligibility, in comparison with a condition that the inputted signal is divided at a fixed frequency into two sound sections, by reason that the inputted sound signal is divided into two sound sections at a frequency which is changed on the basis of the features of the inputted sound signal.

While there has been described in the foregoing description about the fact that the inputted sound signal is divided on the basis of the type of vowel, cutoff frequencies of bandpass filters may be changed on the basis of the combination of continuous syllabic sounds.

The first and second embodiments of the sound processing apparatus according to the present invention will be described hereinafter with reference to accompanying drawings.

### First Embodiment

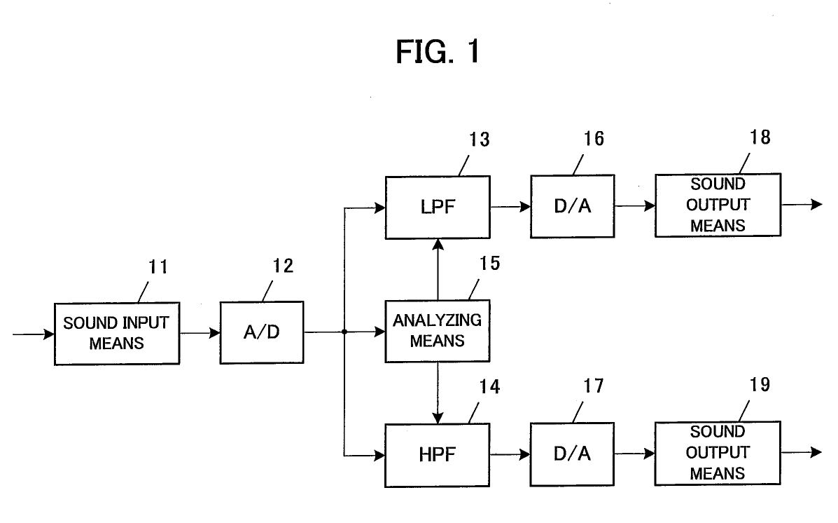

FIG. 1 is a block diagram showing the first embodiment of the sound processing apparatus according to the present invention.

As shown in FIG. 1, the sound processing apparatus comprises sound input means 11 having inputted therein an analog sound signal into which an input sound is converted by a microphone, an audio apparatus, or the like, an analog-to-digital converter (A/D converter) 12 for converting the analog sound signal into a digital sound signal, a lowpass filter 13 having low frequency components of the digital sound signal from the A/D converter 12 passed therethrough, a highpass filter 14 having high frequency components of the digital sound signal from the A/D converter 12 passed therethrough, analyzing means 15 for analyzing the digital sound signal from the A/D converter 12, and changing the cutoff frequencies of the lowpass and highpass filters 13 and 14 on the basis of an analysis of the digital sound signal from the A/D converter 12, a first digital-to-analog converter (first D/A converter) 16 for converting the digital sound signal from the lowpass filter 13 into an analog sound signal, a second digital-to-analog converter (first D/A converter) 17 for converting the digital sound signal from the highpass filter 14 into an analog sound signal, a first sound output means 18 for converting the analog sound signal from the first D/A converter 16 into a sound to be outputting to one of user's ears, and a second sound output means 19 for converting the analog sound signal from the second D/A converter 17 into a sound to be outputted to the other of user's ears.

In the sound processing apparatus thus constructed, the analog sound signal from the sound input means 11 is converted into a digital sound signal by the A/D converter 12, while the digital sound signal is outputted to the lowpass filter 13, the highpass filter 14, and the analyzing means 15.

The analyzing means 15 analyzes the input signal, and to detect a frequency band corresponding to a masking component and a frequency band corresponding to a masked component to be masked by the masking component, and changes the cutoff frequencies of the lowpass and highpass filters 13 and 14 on the basis of the analysis of the input signal to ensure that the masking component is included in the sound to be outputted by one of the first and second sound output means 18 and 19, and the masked component is included in the sound to be outputted by the other of the first and second sound output means 18 and 19.

The analyzing means 15 detects the type of each vowel on the basis of the analysis of the input signal. When the preceding vowel is identified as /a/, the analyzing means 15 sets a cutoff frequency “f2” shown in FIG. 2 to the lowpass and highpass filters 13 and 14. When, on the other hand, the preceding vowel is identified as lul, the analyzing means 15 sets a cutoff frequency “f1” shown in FIG. 2 to the lowpass and highpass filters 13 and 14.

The analyzing means 15 may be adapted to identify the type of the preceding vowel by detecting first and second formant frequencies.

The analyzing means 15 may be adapted to detect a first formant frequency, to change the cutoff frequencies of the lowpass and highpass filters 13 and 14 on the basis of the first formant frequency, and to allow one of the lowpass and highpass filters 13 and 14 to output a component corresponding to the first formant frequency, and to allow the other of the lowpass and highpass. filters 13 and 14 to cut off or attenuate the component corresponding to the first formant frequency.

The lowpass filter 13 outputs frequency components included in frequency bands smaller than the cutoff frequency set by the analyzing means 15, while the highpass filter 14 outputs frequency components included in frequency bands larger than the cutoff frequency set by the analyzing means 15.

The digital signals from the highpass and lowpass filters 13 and 14 are respectively converted into analog signals by the first and second D/A converters 16 and 17, while the analog signals are respectively converted by the first and second sound output means 18 and 19 into sounds to be outputted to user's right and left ears.

From the foregoing description, it will be understood that the sound processing apparatus according to the first embodiment of the present invention can allow a user to hear a sound with improved intelligibility by reason that the analyzing means 15 is adapted to analyze an input signal, to change the cutoff frequencies of the lowpass and highpass filters 13 and 14 on the basis of the analysis of the input signal to ensure that the masking component is included in the sound to be outputted by one of the first and second sound output means 18 and 19, and the masked component is included in the sound to be outputted by the other of the first and second sound output means 18 and 19.

In this embodiment, the sound processing apparatus is adapted to divide the input signal into two sound signals corresponding to right and left ears, one of the sound signals including high frequency components of the input signal, the other of the sound signals including low frequency components of the input signal. However, the sound processing apparatus may be adapted to output a band-limited sound to one of the right and left ears, and to output a sound to the other of the right and left ears without bandwidth constraint. The sound processing apparatus may be adapted to divide the input signal into two or more sound signals.

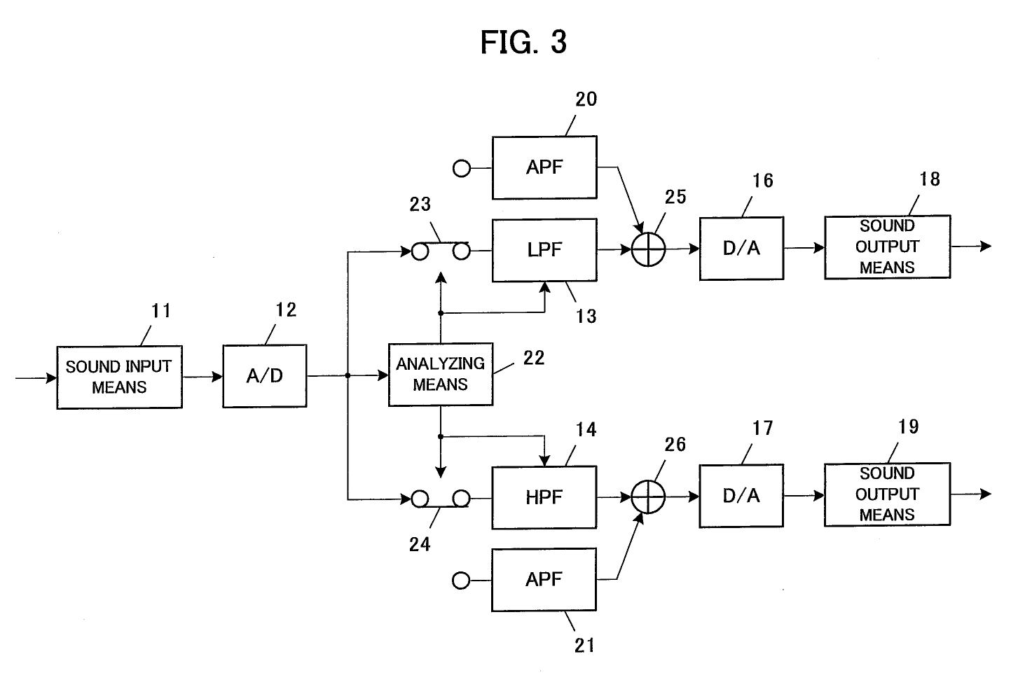

As shown in FIG. 3, the sound processing apparatus may be adapted to switch from the lowpass filter 13 to the all-pass filter 20 and vice versa on a periodic basis, and to switch from the highpass filter 14 to the all-pass filter 21 and vice versa on a periodic basis.

In this case, the analyzing means 22 is adapted to analyze the input signal, and to control the first and second switches 23 and 24 to ensure that the all-pass filters 20 and 21 receives the digital sound signal from the A/D converter 12 when the judgment is made that the sound is sufficiently clear or does not include a voice component, and outputs the digital sound signals to the D/A converters 16 and 17 through the first and second adders 25 and 26, without limiting, in frequency range, the digital sound signals.

From the foregoing description, it will be understood that the sound processing apparatus thus constructed according to the present invention can allow a user to hear a sound by both ears, without changing the sound into two sound sections, when the inputted sound is sufficiently clear or identified as a sound other than a voice.

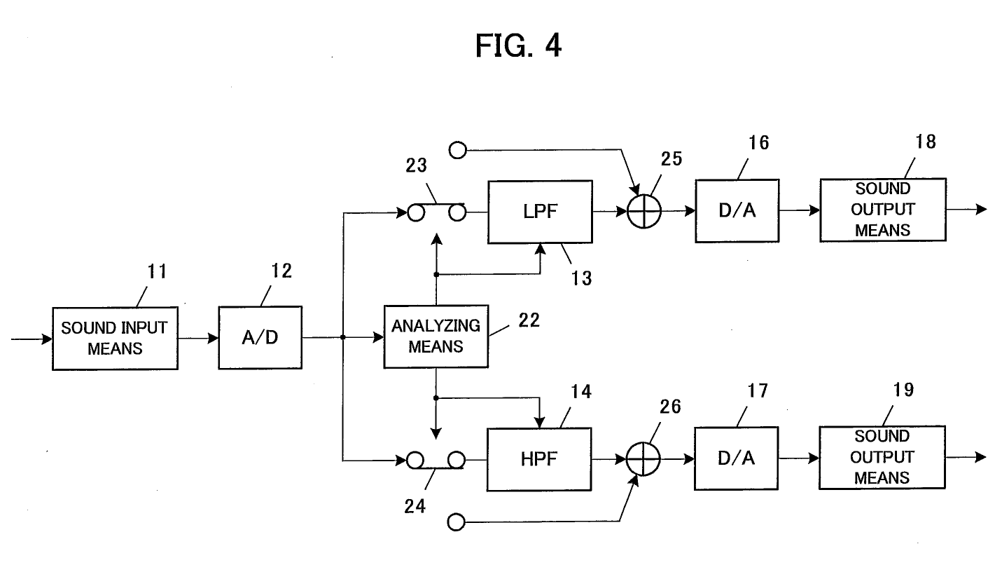

As shown in FIG. 4, the sound processing apparatus may be adapted to allow the first and second switches 23 and 24 to bypass the lowpass and highpass filters 13 and 14 without the all-pass filters 20 and 21.

The analyzing means 15 may be adapted to have the highpass and lowpass filters 13 and 14 function as all-pass filters by changing the filter coefficients of the highpass and lowpass filters 13 and 14.

In this embodiment, the first sound output means 18 is adapted to receive a sound signal from the lowpass filter 13, while the second sound output means 19 is adapted to receive a sound signal from the highpass filter 14. However, the sound processing apparatus may comprise amplifying means for amplifying the sound signals from the highpass and lowpass filters 13 and 14, and outputting the amplified sound signals to the first and second sound outputting means 18 and 19.

### Second Embodiment

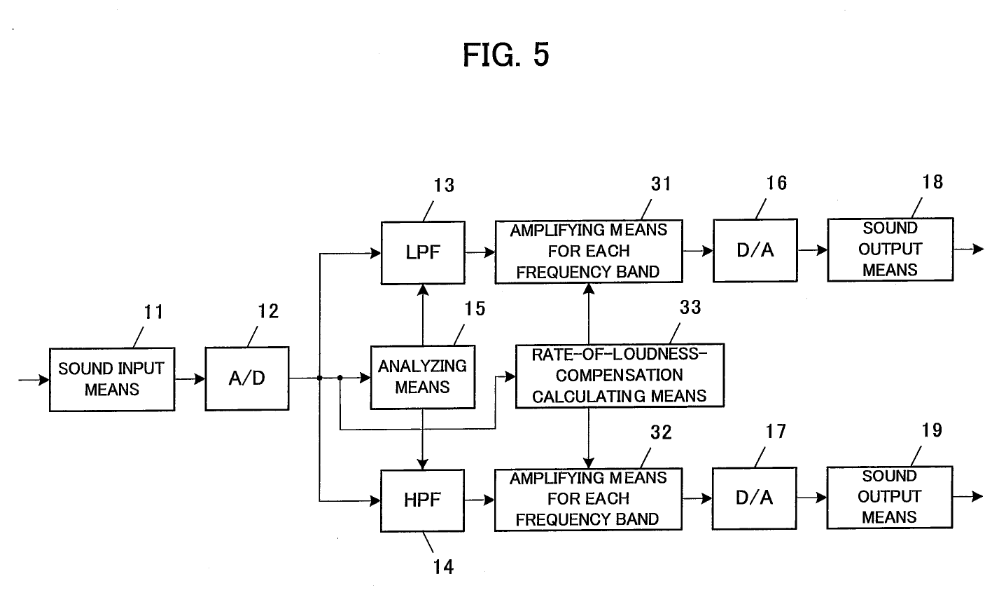

FIG. 5 is a block diagram showing the second embodiment of the sound processing apparatus according to the present invention. The constitution elements of the sound processing apparatus according to the second embodiment are substantially the same as those of the sound processing apparatus according to the first embodiment except for the constitution elements appearing in the following description. Therefore, the constitution elements of the sound processing apparatus according to the second embodiment the same as those of the sound processing apparatus according to the first embodiment will not be described but bear the same reference numbers and legends as those of the sound processing apparatus according to the first embodiment.

The sound processing apparatus according to the second embodiment of the present invention comprises first and second amplifying means 31 and 32 for amplifying, in each frequency band, the right and left channel signals on the basis of gains set in each frequency band, and rate-of-loudness-compensation calculating means 33 for analyzing, in power of each frequency band, the input signal, and adjusting, in each frequency band, the gains of the first and second amplifying means 31 and 32 on the basis of the power of each frequency band.

In the sound processing apparatus thus constructed as previously mentioned, the analog sound signal inputted into the sound input means 11 is converted by the A/D converter 12 to a digital sound signal to be outputted to the lowpass filter 13, the highpass filter 14, the analyzing means 15, and the rate-of-loudness-compensation calculating means 33.

As has been mentioned in the first embodiment, the analyzing means 15 is adapted to analyze the input signal from the sound input means 11, and to adjust cutoff frequencies of the lowpass and highpass filters 13 and 14 on the basis of the analysis of the analyzing means 15.

The rate-of-loudness-compensation calculating means 33 is adapted to analyze, in each frequency band, the energy of the input signal from the sound input means 11, to calculate, in each frequency band, gains of the first and second amplifying means 31 and 32 on the basis of user's right and left auditory properties deteriorated in dynamic range, and to set the calculated gains to the first and second amplifying means 31 and 32 to ensure that the user hears right and left channel sounds amplified appropriately in each frequency band on the basis of the calculated gains.

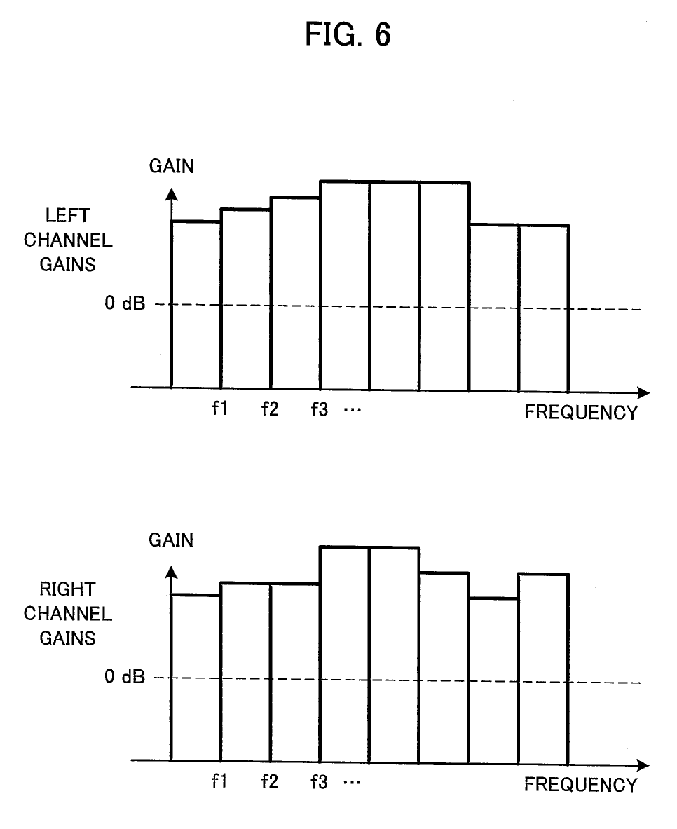

As shown in, for example, FIG. 6, the first and second amplifying means 31 and 32 amplify, in each frequency range, the digital sound signals on the basis of the gains adjusted in each frequency range by the rate-of-loudness-compensation calculating means 33, and output the amplified digital sound signals to the first and second D/A converters 16 and 17, respectively.

The digital sound signals outputted by the first and second amplifying means 31 and 32 are respectively converted into analog sound signals by the first and second D/A converters 16 and 17, while the analog sound signals are respectively outputted by the first and second sound output means 18 and 19.

From the foregoing description, it will be understood that the sound processing apparatus according to the second embodiment of the present invention can improve, in intelligibility, a sound to be heard by the hearing-impaired person by reason that the rate-of-loudness-compensation calculating means 33 is adapted to analyze, in power of each frequency range, the sound signal inputted into the sound input means 11, and to adjust, in each frequency range, the gains of the first and second amplifying means 31 and 32 on the basis of his/her auditory property.

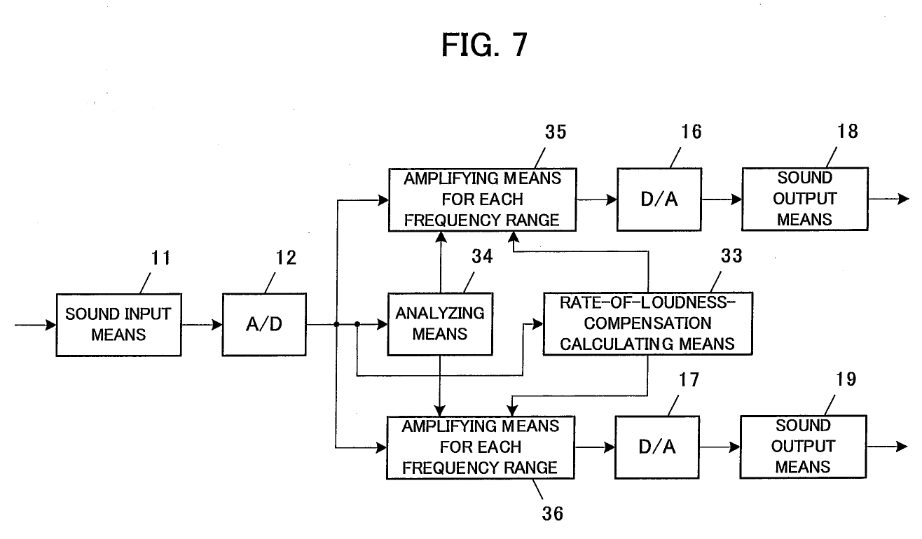

As shown in FIG. 7, the first amplifying means 35 may be adapted to have the low- frequency components of the digital sound signal passed therethrough in place of the lowpass filter 13. The second amplifying means 36 may be adapted to have the high- frequency components of the digital sound signal passed therethrough in place of the highpass filter 14.

In this case, the analyzing means 34 is adapted to analyze, in each frequency range, the sound signal inputted into the sound input means 11, to adjust, in each frequency range, the gains of the first amplifying means 35 on the basis of the analysis of the sound signal to ensure that the first amplifying means 35 has the digital sound signal passed therethrough in low frequency range smaller than a cutoff frequency, and to adjust, in each frequency range, the gains of the second amplifying means 36 on the basis of the analysis of the sound signal to ensure that the second amplifying means 35 has the digital sound signal passed therethrough in high frequency range larger than the cutoff frequency.

In each embodiment, the sound processing apparatus is adapted to change, on the basis of the analysis of the input signal, the input signal into two sound signal sections corresponding to user's right and left ears. However, the sound processing apparatus may have two sound signals inputted therein, and may be adapted to process two input signals on the basis of the changed frequency characteristics. Further, the sound processing apparatus may be adapted to divide the input signal into two or more sound signal sections.

### INDUSTRIAL APPLICABILITY OF THE PRESENT INVENTION

As will be seen from the foregoing description, the sound processing apparatus according to the present invention has an advantageous effect of allowing a hearing- impaired person to hear a sound with improved intelligibility. The sound processing apparatus according to the present invention is useful as a hearing aid apparatus, an audio apparatus, a cellular phone, an apparatus for loudening a sound, an apparatus for performing voice communication, and the like.

What is claimed is:

1. A sound processing apparatus, comprising:
at least one frequency characteristic changing means for changing frequency characteristics corresponding to right and left ears, and changing an input signal on the basis of said changed frequency characteristics; and
analyzing means for analyzing said input signal, and controlling said frequency characteristic changing means on the basis of an analysis of said input signal to allow said frequency characteristic changing means to change said input signal into right and left channel signals corresponding to right and left ears.

2. A sound processing apparatus as set forth in claim 1, in which said analyzing means is adapted to detect, from a plurality of frequency bands of said input signal, a frequency band corresponding to a masking sound and a frequency band corresponding to a masked sound, and to control said frequency characteristic changing means to ensure that said frequency band corresponding to said masking sound is included in one of said right and left channel signals, and said frequency band corresponding to said masked sound is included in the other of said right and left channel signals.

3. A sound processing apparatus as set forth in claim 1, in which said analyzing means is adapted to analyze, in vowel, said input signal, and to allow said frequency characteristic changing means to change said frequency characteristics on the basis of an analysis in vowel of said input signal.

4. A sound processing apparatus as set forth in claim 3, in which said analyzing means is adapted to detect one or more formant frequencies from said input signal, and to identify the type of vowel on the basis of said detected formant frequencies.

5. A sound processing apparatus as set forth in claim 1, in which said analyzing means is adapted to detect a first formant frequency from said input signal, and to allow said frequency characteristic changing means to change said frequency characteristics on the basis of an analysis in vowel of said input signal.

6. A sound processing apparatus as set forth in claim 5, in which said analyzing means is adapted to allow said frequency characteristic changing means to change said frequency characteristics to allow a frequency band corresponding to said first formant frequency to be outputted to one of said ears, and to prevent said frequency band corresponding to said first formant frequency from being outputted to the other of said ears.

7. A sound processing apparatus as set forth in claim 1, in which said frequency characteristic changing means includes lowpass and highpass filters, and in which said analyzing means is adapted to change, in cutoff frequency, said lowpass and highpass filters on the basis of said analysis of said input signal, and to allow said lowpass and highpass filters updated in cutoff frequency to filter said input signal.

8. A sound processing apparatus as set forth in claim 7, in which said analyzing means is adapted to detect, from said a plurality of frequency bands of said input signal, a frequency band corresponding to a masking sound and a frequency band corresponding to a masked sound, and to change, in cutoff frequency, said lowpass and highpass filters on the basis of on the basis of said detected frequency bands.

9. A sound processing apparatus as set forth in claim 7, which further comprises two amplifying means for amplifying said frequency bands of said input signal on the basis of adjustable gains corresponding to said frequency bands of said input signal; and
rate-of-loudness-compensation calculating means for calculating powers of said frequency bands of said input signal, and adjusting said gains of said amplfying means on the basis of said calculated powers of said frequency bands of said input signal, wherein said rate-of-loudness-compensation calculating means is adapted to amplify signals passed through said lowpass and highpass filters on the basis of said gains updated by said rate-of-loudness-compensation calculating means.

10. A sound processing apparatus as set forth in claim 7, in which said analyzing means is adapted to detect first and second formant frequencies from said input signal, to identify the type of vowel on the basis of said detected first and second formant frequencies, and to change, in cutoff frequency, said lowpass and highpass filters on the basis of an analysis in vowel of said input signal.
